(19) United States
(12) Patent Application Publication
(10) Pub. No.: US 2012/0195571 A1
(43) Pub. Date: Aug. 2, 2012

(54) IMAGE PROCESSING APPARATUS

(75) Inventor: Katsunori Matsuda, Daito-shi (JP)

(73) Assignee: SANYO ELECTRIC CO., LTD., Osaka (JP)

(21) Appl. No.: 13/362,709

(22) Filed: Jan. 31, 2012

(30) Foreign Application Priority Data
Jan. 31, 2011 (JP) 2011-018503

(51) Int. Cl. H04N 9/80

(52) U.S. Cl. 386/241; 386/E09.011

(57) ABSTRACT

An image processing apparatus includes a selector. A selector selects a desired frame image from among a plurality of frame images forming each of one or at least two moving images. A creator creates a still image based on the frame image selected by the selector. A first reproducer reproduces any one of one or at least two still image created by the creator, in response to a still-image reproduction instruction. A detector detects, from among one or at least two moving images, a specific moving image having a frame image which is a basis for the still image reproduced by the first reproducer when a predetermined operation for the still image reproduced by the first reproducer is accepted. A second reproducer reproduces the specific moving image detected by the detector by using the frame image noticed by the detector as a reference.

### CROSS REFERENCE OF RELATED APPLICATION

The disclosure of Japanese Patent Application No. 2011-18503, which was filed on Jan. 31, 2011, is incorporated here by reference.

### BACKGROUND OF THE INVENTION

1. Field of the Invention

The present invention relates to an image processing apparatus. More particularly, the present invention relates to an image processing apparatus which reproduces a moving image.

2. Description of the Related Art

According to one example of this type of apparatus, a previously designated number of still images by a user are extracted from each of moving image files already accommodated. The extracted still images are displayed on predetermined positions after arranged in an any previously designated by the user. When a displayed still image is selected by the user, a moving image corresponding to the selected image is displayed.

However, in the above-described apparatus, a start position of reproducing the moving image is not described. Therefore, when an operator wishes to reproduce the moving image by using a desired frame image as a reference, it is necessary to discover a reproducing start position by searching from a head position of the moving image in order, and thereby, an operability is decreased.

### SUMMARY OF THE INVENTION

An image processing apparatus according to the present invention, comprises: a selector which selects a desired frame image from among a plurality of frame images forming each of one or at least two moving images; a creator which creates a still image based on the frame image selected by the selector; a first reproducer which reproduces any one of one or at least two still image created by the creator, in response to a still-image reproduction instruction; a detector which detects, from among one or at least two moving images, a specific moving image having a frame image which is a basis for the still image reproduced by the first reproducer when a predetermined operation for the still image reproduced by the first reproducer is accepted; and a second reproducer which reproduces the specific moving image detected by the detector by using the frame image noticed by the detector as a reference.

According to the present invention, an image processing program recorded in a non-transitory recording medium in order to control an image processing apparatus, comprising following steps executed by a processor of the image processing apparatus: a selecting step of selecting a desired frame image from among a plurality of frame images forming each of one or at least two moving images; a creating step of creating a still image based on the frame image selected by the selecting step; a first reproducing step of reproducing any one of one or at least two still image created by the creating step, in response to a still-image reproduction instruction; a detecting step of detecting, from among one or at least two moving images, a specific moving image having a frame image which is a basis for the still image reproduced by the first reproducing step when a predetermined operation for the still image reproduced by the first reproducing step is accepted; and a second reproducing step of reproducing the specific moving image detected by the detecting step by using the frame image noticed by the detecting step as a reference.

According to the present invention, an image processing method executed by an image processing apparatus, comprises: a selecting step of selecting a desired frame image from among a plurality of frame images forming each of one or at least two moving images; a creating step of creating a still image based on the frame image selected by the selecting step; a first reproducing step of reproducing any one of one or at least two still image created by the creating step, in response to a still-image reproduction instruction; a detecting step of detecting, from among one or at least two moving images, a specific moving image having a frame image which is a basis for the still image reproduced by the first reproducing step when a predetermined operation for the still image reproduced by the first reproducing step is accepted; and a second reproducing step of reproducing the specific moving image detected by the detecting step by using the frame image noticed by the detecting step as a reference.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a mapping state of an SDRAM applied to the embodiment in FIG. 2;

FIG. 4 is an illustrative view showing one example of a data structure of a moving image file created by the embodiment in FIG. 2;

FIG. 5 is an illustrative view showing one example of a view of an LCD monitor when a still image is designated in a reproducing task;

FIG. 6 is an illustrative view showing one example of a view of the LCD monitor when a moving image is designated in the reproducing task;

FIG. 7 is an illustrative view showing one example of a view of the LCD monitor while the moving image is reproduced;

FIG. 8 is an illustrative view showing one example of a view of the LCD monitor when the moving image is suspended to be reproduced;

FIG. 9 is an illustrative view showing one example of a configuration of an Exif tag created by the embodiment in FIG. 2;

FIG. 10 is an illustrative view showing one example of a still image created by the embodiment in FIG. 2;

FIG. 11 is an illustrative view showing another example of the view of the LCD monitor when the still image is designated in the reproducing task;

FIG. 12 is an illustrative view showing another example of the view of the LCD monitor while the moving image is being reproduced;

FIG. 13 is an illustrative view showing one example of a message displayed on the LCD monitor;

FIG. 14 is a flowchart showing one portion of behavior of a CPU applied to the embodiment in FIG. 2;

FIG. 15 is a flowchart showing another portion of behavior of the CPU applied to the embodiment in FIG. 2;

FIG. 16 is a flowchart showing still another portion of behavior of the CPU applied to the embodiment in FIG. 2;

FIG. 17 is a flowchart showing yet another portion of behavior of the CPU applied to the embodiment in FIG. 2; and

FIG. 18 is a block diagram showing a configuration of another embodiment of the present invention.

### DETAILED DESCRIPTION OF THE PREFERRED EMBODIMENTS

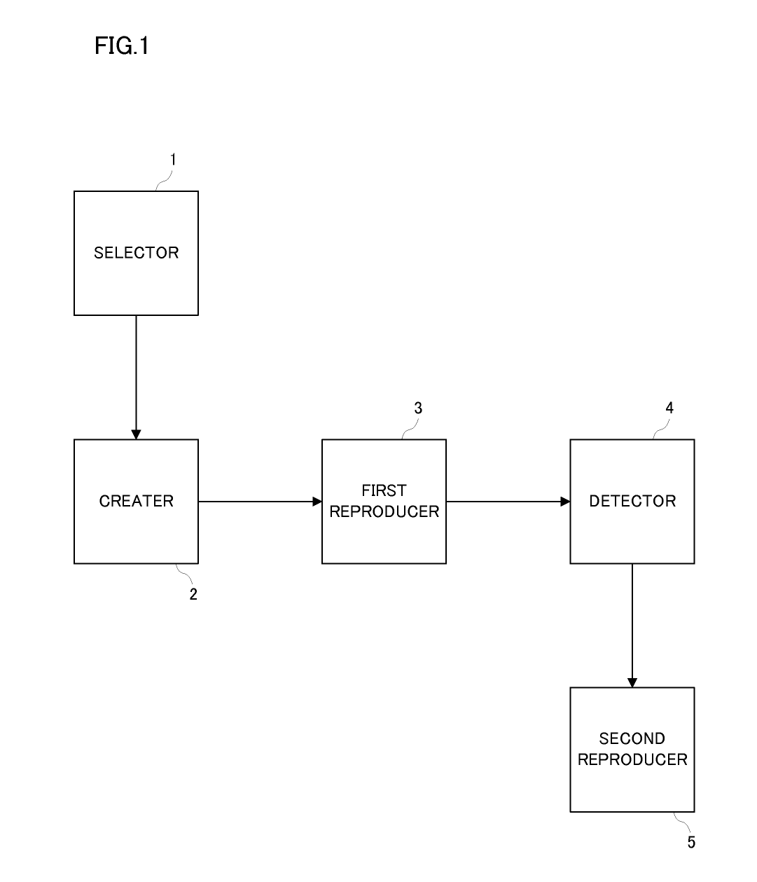

With reference to FIG. 1, an image processing apparatus according to one embodiment of the present invention is basically configured as follows: A selector 1 selects a desired frame image from among a plurality of frame images forming each of one or at least two moving images. A creator 2 creates a still image based on the frame image selected by the selector 1. A first reproducer 3 reproduces any one of one or at least two still image created by the creator 2, in response to a still-image reproduction instruction. A detector 4 detects, from among one or at least two moving images, a specific moving image having a frame image which is a basis for the still image reproduced by the first reproducer 3 when a predetermined operation for the still image reproduced by the first reproducer 3 is accepted. A second reproducer 5 reproduces the specific moving image detected by the detector 4 by using the frame image noticed by the detector 4 as a reference.

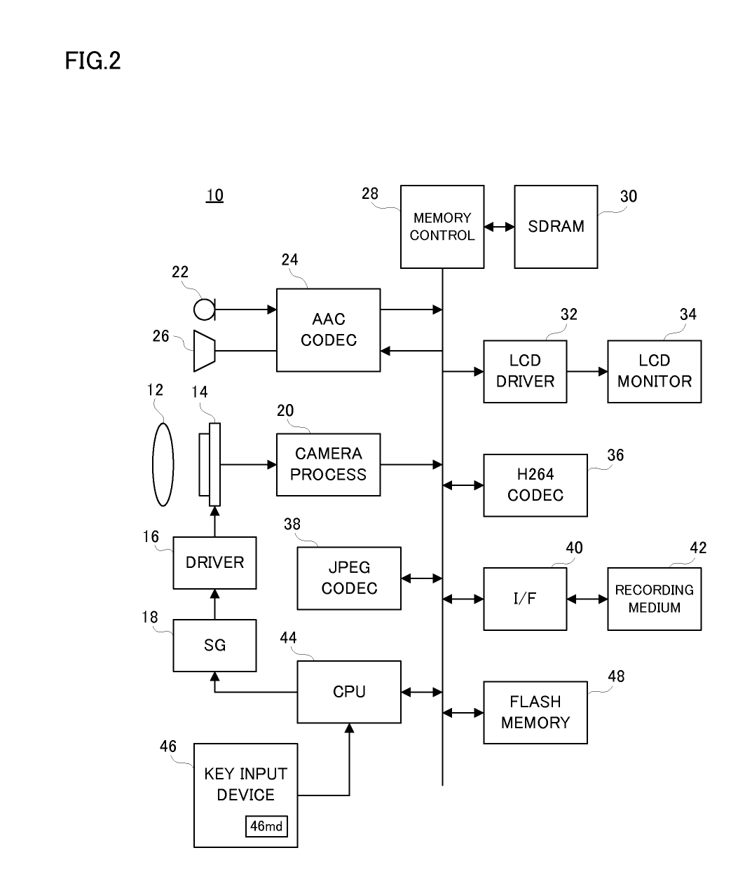

With reference to FIG. 2, a digital video camera 10 according to this embodiment includes an optical lens 12. An optical image representing a scene is irradiated onto an imaging surface of an imaging device 14 through the optical lens 12. Thereby, electric charges representing a scene image are produced.

A CPU 44 starts up an imaging task when a camera mode is selected by a mode setting switch 46md arranged in a key input device 46 whereas starts up a reproducing task when a reproducing mode is selected by the same mode setting switch 46md.

When the imaging task is started up, in order to execute a moving-image taking process under the imaging task, the CPU 44 commands a driver 16 to repeat a pre-exposure procedure and a pixel-skipping reading-out procedure. In response to a vertical synchronization signal Vsync generated from an SG (Signal Generator) 18, the driver 16 performs the pre-exposure on the imaging surface and also reads out in a pixel-skipping manner, the electric charges produced on the imaging surface in a raster scanning direction. From the imaging device 14, raw image data based on the read-out electric charges is outputted at every 1/60th of a second.

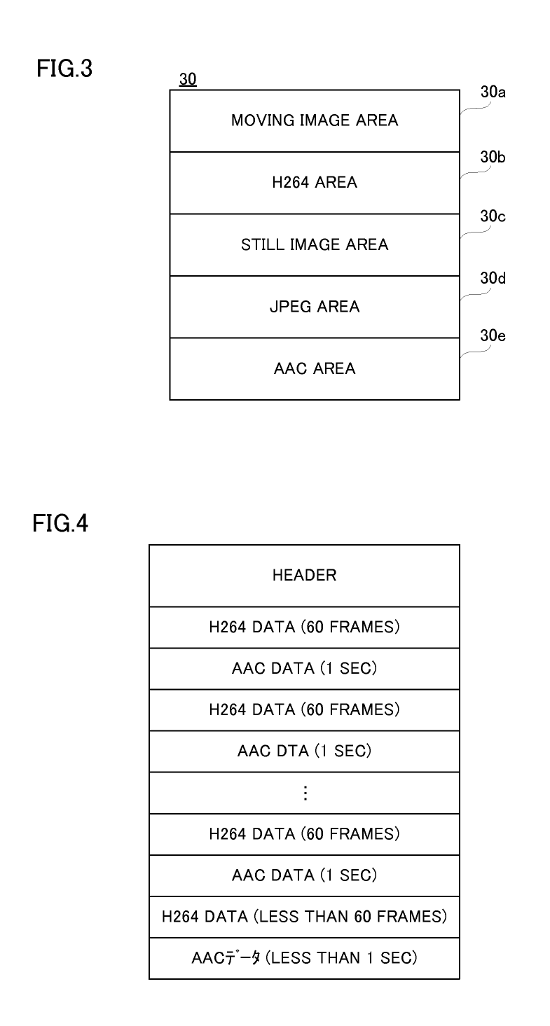

A camera processing circuit 20 performs processes, such as a white balance adjustment, a color separation, and a YUV conversion, on the raw image data outputted from the imaging device 14 so as to write YUV-formatted image data thus created into a moving image area 30a of an SDRAM (see FIG. 3) through a memory control circuit 28. An LCD driver 32 repeatedly reads out the image data accommodated in the moving image area 30a through the memory control circuit 28, and drives an LCD monitor 34 based on the read-out image data. As a result, a live view image representing the scene is displayed on the LCD monitor 34.

When a still-image recording operation is performed in this state by the key input device 46, the CPU 44 commands the driver 16 to execute a main exposure procedure and an all-pixel reading procedure once each. The driver 16 performs the main exposure on the imaging surface in response to generating of the vertical synchronization signal Vsync, and reads out all the electric charges produced in an electric-charge reading-out area in a raster scanning manner. As a result, one frame of raw image data having a high resolution is outputted from the imaging device 14. The outputted raw image data having the high-resolution is subjected to processes similar to those described above, and as a result, high-resolution image data according to a YUV format is secured in a still image area 30c of the SDRAM 30 (see FIG. 3).

The moving image taking process described above is interrupted by executing the main exposure procedure and the all-pixel reading procedure. Moreover, a generation process of the vertical synchronization signal Vsync by the SG 18 is temporarily interrupted after the raw image data having the high-resolution is outputted from the imaging device 14.

Furthermore, the CPU 44 commands a JPEG codec 38 to execute a still-image compressing process. The JPEG codec 38 reads out the image data secured in the still image area 30c through the memory control circuit 28, compresses the read-out image data by the JPEG format, and writes the compressed image data thus obtained, i.e., JPEG data, into a JPEG area 30d of the SDRAM 30 (see FIG. 3) through the memory control circuit 28.

The CPU 44 reads out the JPEG data accommodated in the JPEG area 30d through the memory control circuit 28 so as to write the read-out JPEG data into a still image file created in a recording medium 42 through an I/F 40.

The CPU 44 restarts the SG 18 at a time point at which the JPEG data is secured in the JPEG area 30d so as to start the moving-image taking process. As a result, the live view image is outputted from the LCD monitor 34.

When a moving-image recording-start operation is performed by the key input device 46 in the middle of the moving-image taking process, the CPU 44 accesses the recording medium 42 through the I/F 40 under the imaging task so as to newly create a moving image file onto the recording medium 42 (the created moving-image file is opened).

Upon completion of the process for creating and opening the file, the CPU 44 commands an H264 codec 36 to start an H264 encoding process, and commands an AAC codec 24 to start an AAC encoding process.

The H264 codec 36 repeatedly reads out the image data accommodated in the moving-image area 30a through the memory control circuit 28, encodes the read-out image data according to the H264 format, and writes the encoded image data, i.e., H264 data into an H264 area 30b of the SDRAM 30 (see FIG. 3) through the memory control circuit 28.

The AAC codec 24 encodes sound data outputted from a microphone 22 according to the AAC format, and writes the encoded sound data, i.e., AAC data into an AAC area 30e of the SDRAM 30 (see FIG. 3) through the memory control circuit 28.

Thereafter, the CPU 44 transfers the latest 60 frames of H264 data and the latest one second of AAC data to a moving image file in an opened state at every time 60 frames of the H264 data is obtained. The latest 60 frames of the H264 data and the latest one second of the AAC data are read out from the H264 area 30b and the AAC area 30e by the memory control circuit 28 so as to be written into the moving image file through the I/F 40. Thus, the H264 data and the AAC data are contained in the moving image file as shown in FIG. 4.

When a moving-image recording-end operation is performed by the key input device 46, the CPU 44 commands the H264 codec 36 to stop the H264 encoding process and commands the AAC codec 24 to stop the AAC encoding process, and thereafter, executes a remained-data transfer process. Less than 60 frames of the H264 data and less than one second of the AAC data remaining in the SDRAM 30 are written into the moving image file by the remained-data transfer process. The moving image file in the opened state is closed after the remained-data transfer process is completed.

When the reproducing task is started up, the CPU 44 designates the latest image file recorded in the recording medium 42. When the still image is designated, the CPU 44 reads out JPEG data of the designated still image file from the recording medium 42 through the I/F 40 so as to write the read-out JPEG data into the JPEG area 30d of the SDRAM 30 through the memory control circuit 28. Moreover, the CPU 44 commands the JPEG codec 38 and the LCD driver 32 to execute a reproducing process for the designated still image file.

The JPEG codec 38 reads out the JPEG data accommodated in the JPEG area 30d through the memory control circuit 28, decodes the read-out image data by the JPEG format, and writes the decoded image data into the still image area 30c of the SDRAM 30 through the memory control circuit 28.

The LCD driver 32 reads out the image data accommodated in the still image area 30c through the memory control circuit 28 so as to drive the LCD monitor 34 based on the read-out image data. As a result, a still image is displayed on the LCD monitor 34 as shown in FIG. 5.

When an updating operation is performed by the key input device 46, the CPU 44 designates a succeeding image file or a preceding image file. When the still image file is designated, the designated still-image file is subjected to the reproducing process similar to that described above, and as a result, a display of the LCD monitor 34 is updated.

When the moving image file is designated, the CPU 44 reads out head-frame image data out of the H264 data accommodated in the designated moving image file, from the recording medium 42 through the I/F 40, and writes the read-out image data into the H264 area 30b of the SDRAM 30 through the memory control circuit 28. Moreover, the CPU commands the H264 codec 36 and the LCD driver 32 to execute a reproducing process for a head frame of the designated moving image file.

The H264 codec 36 reads out the image data accommodated in the H264 area 30b through the memory control circuit 28, decodes the read-out image data by the H264 format, and writes the decoded image data into the moving image area 30a of the SDRAM 30 through the memory control circuit 28.

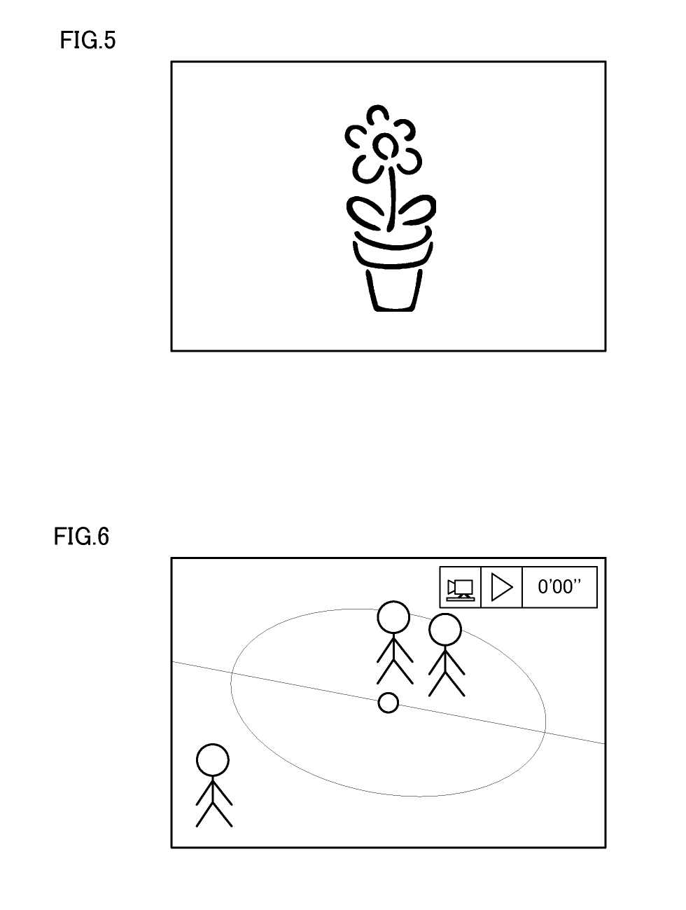

The LCD driver 32 reads out the image data accommodated in the moving image area 30a through the memory control circuit 28, and drives the LCD monitor 34 based on the read-out image data. As a result, a head-frame image is displayed on the LCD monitor 34 as shown in FIG. 6.

When a moving-image reproducing operation is performed in this state by the key input device 46, the CPU 44 periodically reads out a plurality of frames of the H264 data accommodated in the designated moving-image file through the I/F 40, and writes the read-out H264 data into the H264 area 30b of the SDRAM 30 through the memory control circuit 28. Moreover, the CPU 44 periodically reads out the AAC data accommodated in the designated moving-image file through the I/F 40, and writes the read-out AAC data into the AAC area 30e of the SDRAM 30 through the memory control circuit 28. Furthermore, the CPU 44 commands the H264 codec 36, the LCD driver 32 and the AAC codec 24 to start the moving image reproduction.

The H264 codec 36 reads out the H264 data accommodated in the H264 area 30b through the memory control circuit 28, decodes the read-out H264 data, and writes the decoded image data into the moving image area 30a of the SDRAM 30 through the memory control circuit 28.

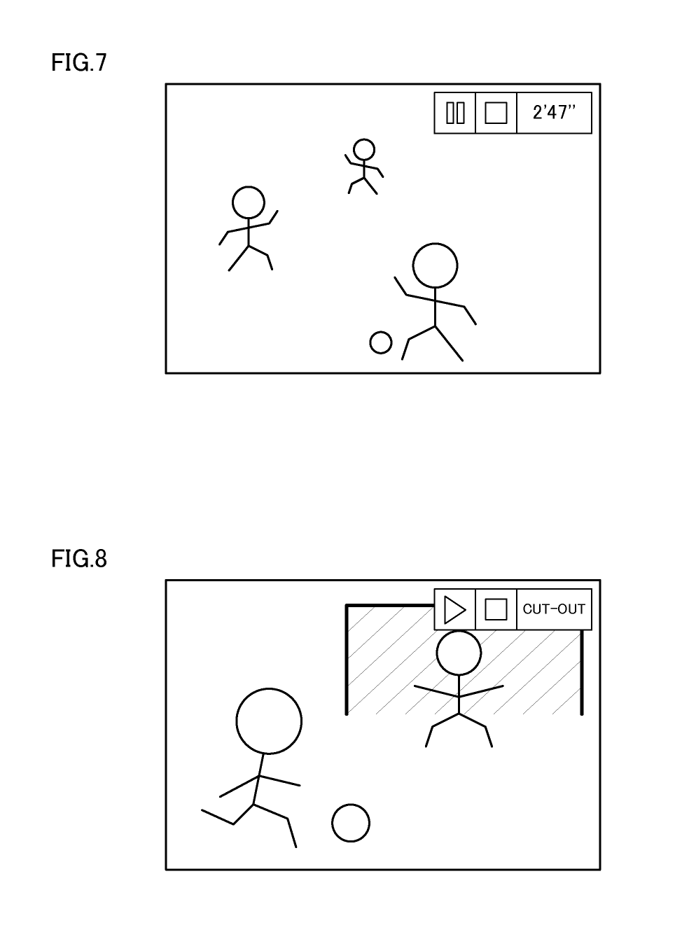

The LCD driver 32 reads out the image data thus accommodated in the moving image area 30a through the memory control circuit 28, and drives the LCD monitor 34 based on the read-out image data. As a result, a moving image is displayed on the LCD monitor 34 as shown in FIG. 7.

On the other hand, the AAC codec 24 reads out the AAC data accommodated in the AAC area 30e through the memory control circuit 28, decodes the read-out AAC data, and applies the decoded sound data to a speaker 26. As a result, a reproduced sound is outputted from the speaker 26 in synchronization with the reproduced moving image.

When a reproducing end operation is performed by the key input device 46 or when the reproduced image has reached a tail end frame image of the designated moving image file, in order to end the reproducing process, the CPU 44 commands the H264 codec 36 to stop an H264 decoding process and commands the AAC codec 24 to stop an AAC decoding process. Thereby, outputting the reproduced moving image and the reproduced sound is stopped.

Moreover, the CPU 44 commands the H264 codec 36 to execute the H264 decoding process for the head-frame image. The head-frame image data is subjected to the decoding process similar to that described above, and as a result, the head-frame image of the designated moving image file is displayed on the LCD monitor 34 again.

When the updating operation is performed by the key input device 46, the CPU 44 designates the succeeding image file or the preceding image file. When the still image file is designated, the designated still-image file is subjected to the still-image reproducing process similar to that described above, and as a result, the display of the LCD monitor 34 is updated. When the moving image file is designated, the designated moving image file is subjected to the head-frame reproducing process similar to that described above, and as a result, the display of the LCD monitor 34 is updated.

When a suspending operation is performed by the key input device 46 while the moving image is being displayed, in order to suspend the reproducing process, the CPU 44 commands the H264 codec 36 to stop the H264 decoding process, and commands the AAC codec 24 to stop the AAC decoding process. As a result, outputting the reproduced moving image and the reproduced sound is suspended, and as shown in FIG. 8, a display of image data on the LCD monitor 34 at a time point at which the suspending operation is performed is maintained.

When a reproduction resuming operation is performed in this state by the key input device 46, the CPU 44 commands the H264 codec 36 to resume the H264 decoding process. As a result, displaying the moving image on the LCD monitor 34 is resumed.

When a cut-out operation is performed by the key input device 46 while displaying the moving image is being suspended, the CPU 44 reads out, from the moving image area 30a of the SDRAM 30, the image data of a frame maintained to be displayed on the LCD monitor 34, and writes the read-out image data into the still image area 30c of the SDRAM 30 through the memory control circuit 28.

Moreover, the CPU 44 commands the JPEG codec 38 to execute the still-image compressing process. The JPEG codec 38 reads out the image data accommodated in the still image area 30c through the memory control circuit 28, compresses the read-out image data by the JPEG system, and writes the compressed image data thus obtained, i.e., JPEG data, into the JPEG area 30d of the SDRAM 30 through the memory control circuit 28.

The CPU 44 acquires a frame number in an original moving image file of the frame which is maintained to be displayed on the LCD monitor 34 through the memory control circuit 28 and the I/F 40. Moreover, the CPU 44 acquires a file name and photographing time and date of the original moving image file through the memory control circuit 28 and the I/F 40.

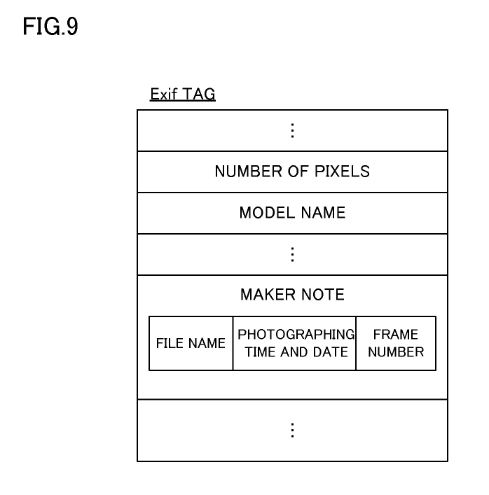

Moreover, the CPU 44 creates a header of a still image file for accommodating the JPEG data by using the acquired file name, the photographing time and date and the frame number. The file name, the photographing time and date, and the frame number are described in a maker note of an Exif tag within the header as shown in FIG. 9.

Furthermore, the CPU 44 creates the still image file within the recording medium 42 by using the above-described header, reads out the image data accommodated in the JPEG area 30d through the memory control circuit 28, and writes the read-out image data into the created still image file.

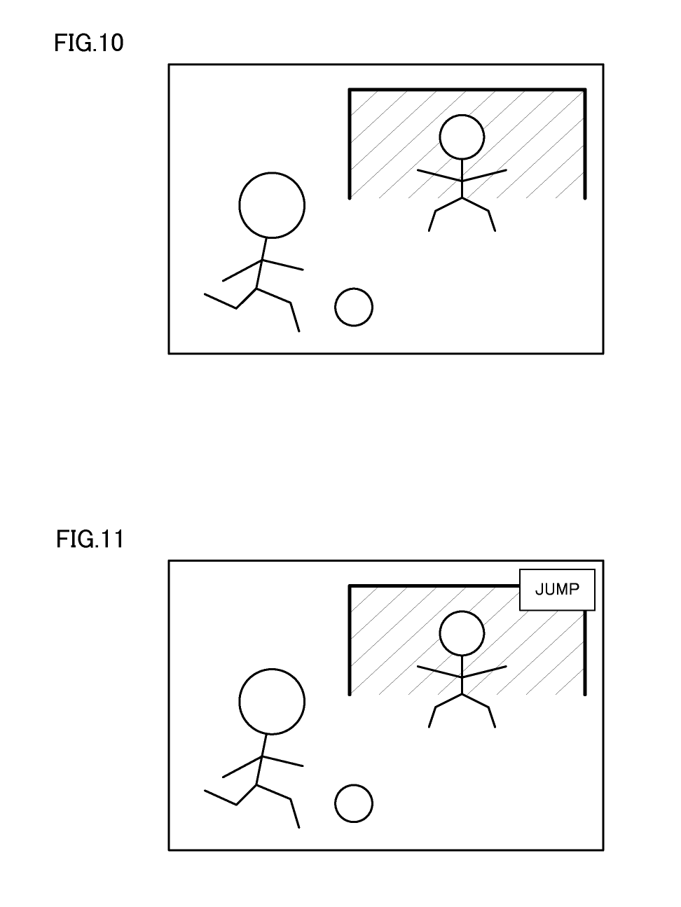

As a result, when the cut-out operation is performed in a suspended screen shown in FIG. 8, a still image file which accommodates a still image shown in FIG. 10 is created in the recording medium 42.

When the still image file created by the cut-out operation is designated while the reproducing task is being started up, the still image is displayed on the LCD monitor 34, and concurrently, an icon indicating a possibility of a moving image jumping operation is displayed on the LCD monitor 34 as shown in FIG. 11.

When the moving image jumping operation is performed by the key input device 46, the CPU 44 refers to the file name described in the maker note of the Exif tag within the header of the designated still image file. The CPU 44 searches for a moving image file having the referred file name in the recording medium 42 through the I/F 40.

When one moving image file is discovered by the searching process, the CPU 44 refers to the photographing time and date described in the maker note of the designated still image file, and determines whether or not the referred photographing time and date is coincident with a photographing time and date of the moving image file. When equal to or more than two moving image files are discovered, the CPU 44 refers to the photographing time and date described in the maker note, and determines whether or not there is a moving image file in which a photographing time and date coincident with the referred photographing time and date is described. When there is the moving image file of which photographing time and date is coincident, the moving image file of which photographing time and date is coincident is regarded as a moving image file of a cut-out resource, and is determined as a target of the moving-image jumping.

Subsequently, the CPU 44 refers to the frame number described in the maker note of the designated still image file so as to calculate a reproducing start position of AAC data corresponding to the referred frame number.

Upon completion of calculation of the reproducing start position of the AAC data, the CPU 44 periodically reads out through the I/F 40 a plurality of frames of H264 data after the reference frame number out of the H264 data accommodated in the moving image file of the moving-image jumping target, and writes the read-out H264 data into the H264 area 30b of the SDRAM 30 through the memory control circuit 28. Moreover, the CPU 44 periodically reads out AAC data after the calculated reproducing start position from the moving image file of the moving-image jumping target, and writes the read-out AAC data into the AAC area 30e of the SDRAM 30 through the memory control circuit 28. Furthermore, the CPU 44 commands the H264 codec 36, the LCD driver 32 and the AAC codec 24 to start the moving image reproduction.

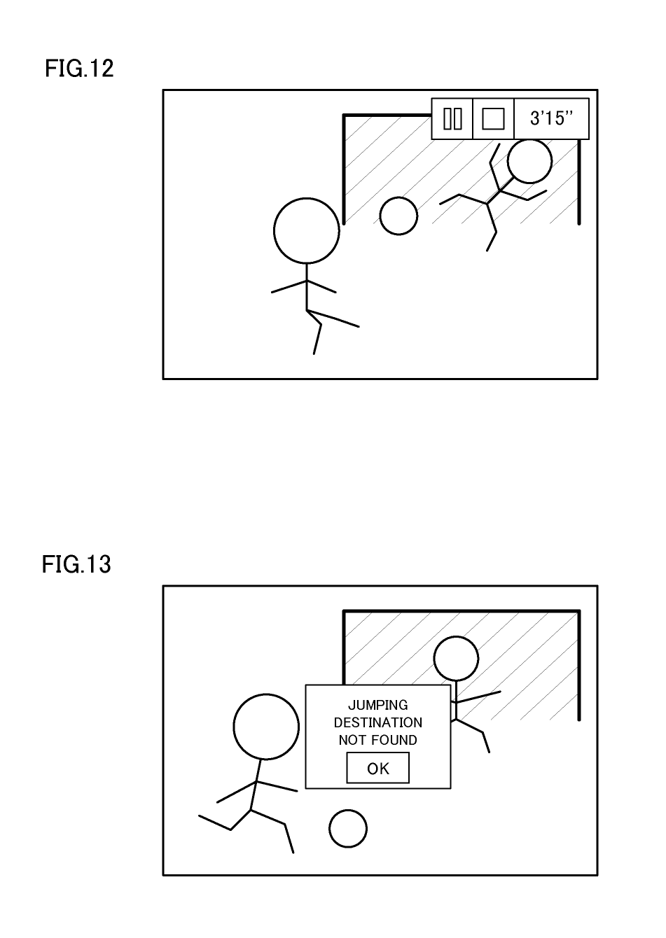

As a result, a moving image based on the frame after the reference frame number is displayed on the LCD monitor 34 as shown in FIG. 12. Moreover, a reproduced sound after the calculated reproducing start position is outputted from the speaker 26 in synchronization with the reproduced moving image.

After starting the moving image reproduction, the reproducing process similar to that for a normal moving image file is executed. Thus, when the reproducing end operation is performed by the key input device 46 or when the reproduced image has reached the tail end frame image of the designated moving image file, the process similar to that described above is performed, and then, the reproducing process is ended. Moreover, when the suspending operation is performed by the key input device 46 while the moving image is being displayed, the process similar to that described above is performed, and then, the reproducing process is suspended.

Furthermore, when the cut-out operation is performed by the key input device 46 while displaying the moving image is being suspended, a still image file which accommodates the still image of the frame displayed on the LCD monitor 34 at a time of suspending is created in the recording medium 42. It is possible to perform the above-described moving-image jumping at a time of reproducing the still image file thus created.

When the moving image file has not been discovered, or when there is no moving image file of which photographing time and date is coincident, it is regarded that the moving image file of the cut-out resource is deleted, and then, the CPU 44 deletes the file name, the photographing time and date and the frame number described in the maker note of the designated still image file. Moreover, the icon indicating the possibility of the moving image jumping operation is hidden, and a message indicating that a moving image file of a jumping destination has not been discovered is displayed on the LCD monitor 34 as shown in FIG. 13. When an operation of confirming the message is performed by the key input device 46, the reproducing process for the normal still image file is continued.

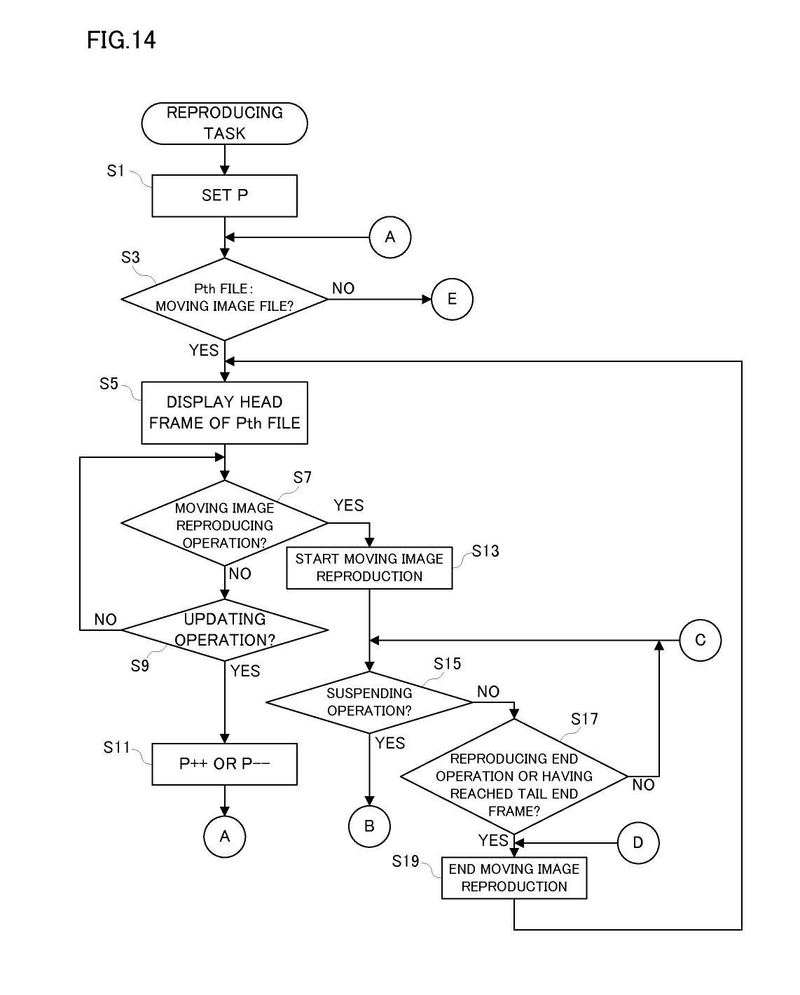

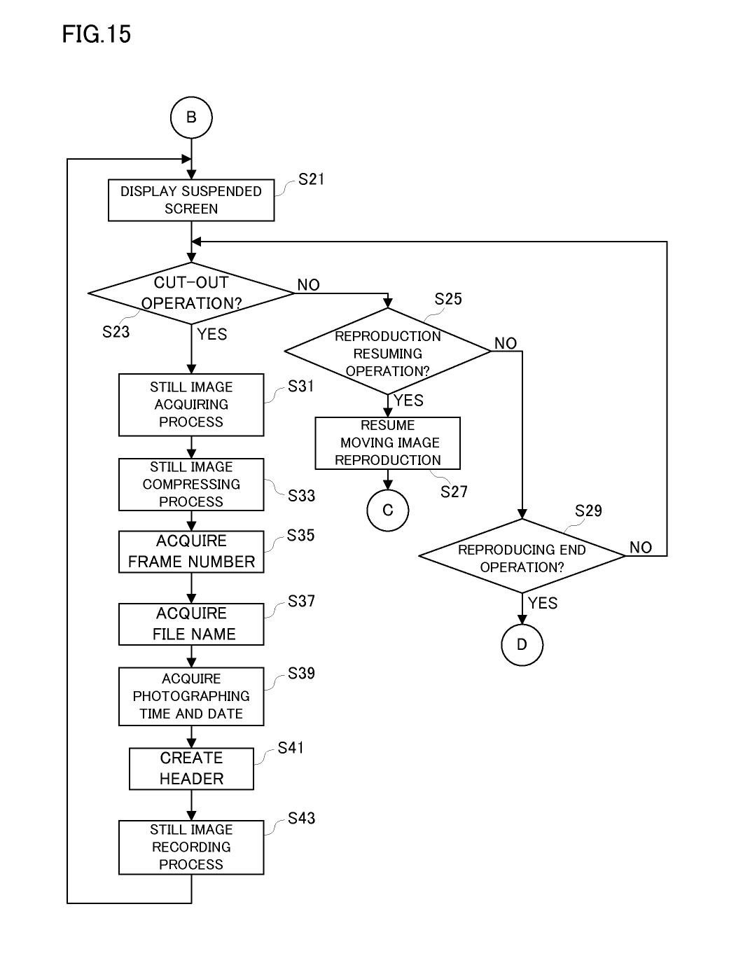

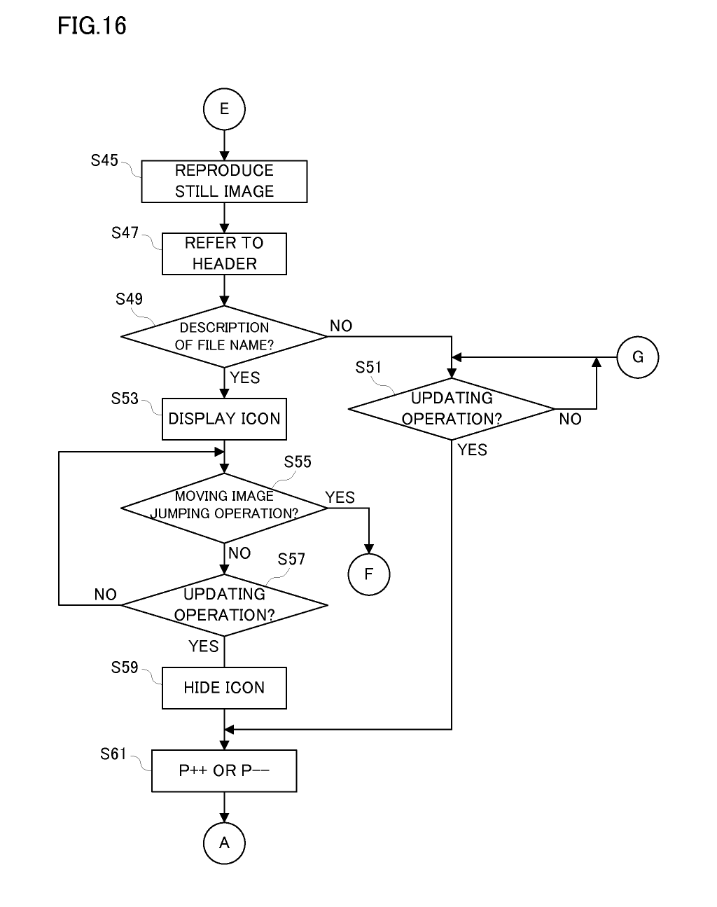

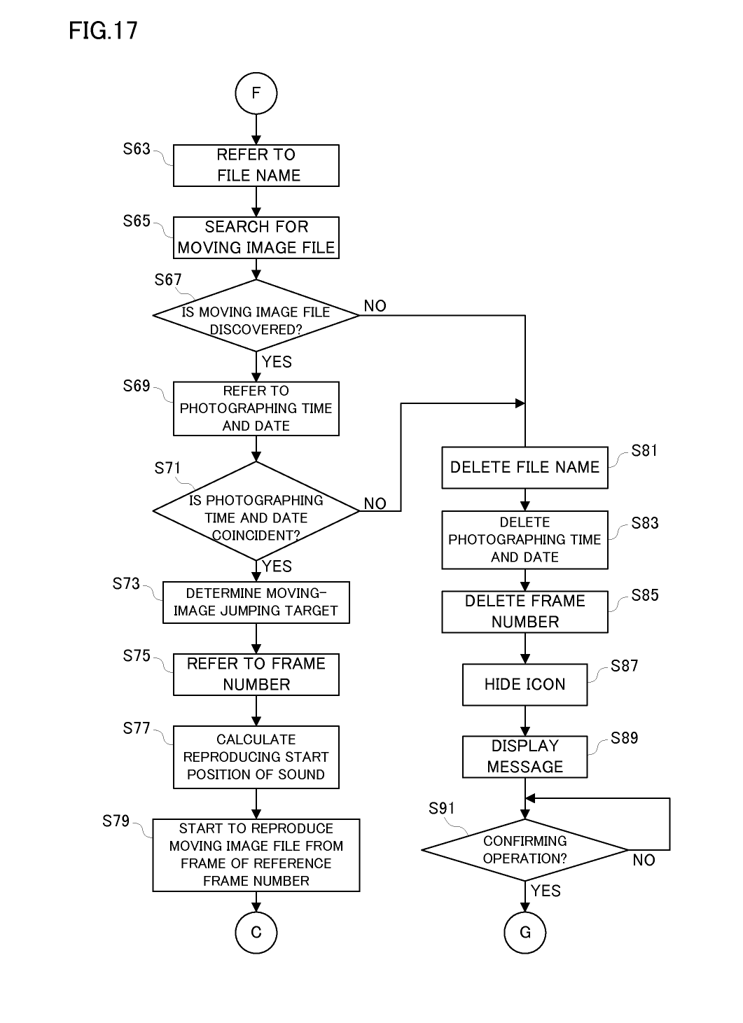

The CPU 44 executes a plurality of tasks including the reproducing task shown in FIG. 14 to FIG. 17. It is noted that, control programs corresponding to these tasks are stored in a flash memory 48.

With reference to FIG. 14, in a step S1, a number indicating the latest image file is set to a variable P, and in a step S3, it is determined whether or not a P-th image file recorded in the recording medium 42 is a moving image file. When a determined result is NO, the process advances to a step 45 whereas when the determined result is YES, in a step S5, the H264 codec 36 and the LCD driver 32 are commanded to execute the reproducing process for a head frame of the P-th image file. As a result, a head frame image is displayed on the LCD monitor 34.

In a step S7, it is determined whether or not the moving-image reproducing operation is performed by the key input device 46, and when a determined result is YES, the process advances to a step S13 whereas when the determined result is NO, in a step S9, it is determined whether or not the updating operation for the reproduced file is performed by the key input device 46.

When a determined result of the step S9 is NO, the process returns to the step S7 whereas when the determined result of the step S9 is YES, in a step S11, the variable P is incremented or decremented, and thereafter, the process returns to the step S3.

In a step S13, the H264 codec 36, the LCD driver 32 and the AAC codec 24 are commanded to start the moving image reproduction. As a result, a moving image is displayed on the LCD monitor 34, and a reproduced sound is outputted from the speaker 26 in synchronization with the reproduced moving image.

In a step S15, it is determined whether or not the suspending operation is performed by the key input device 46, and when a determined result is YES, the process advances to a step S21 whereas when the determined result is NO, in a step S17, it is determined whether or not the reproducing end operation is performed by the key input device 46 or the reproduced image has reached a tail end frame image of the designated moving image file.

When a determined result of the step S17 is NO, the process returns to the step S15 whereas when the determined result of the step S17 is YES, in a step S19, in order to end the reproducing process, the H264 codec 36 is commanded to stop the H264 decoding process and the AAC codec 24 is commanded to stop the AAC decoding process. As a result, outputting the reproduced moving image and the reproduced sound is stopped. Upon completion of the process in the step S19, the process returns to the step S5.

In the step S21, the H264 codec 36 is commanded to stop the H264 decoding process, and the AAC codec 24 is commanded to stop the AAC decoding process. As a result, outputting the reproduced moving image and the reproduced sound is suspended, and a display of image data on the LCD monitor 34 at a time point at which the suspending operation is performed is maintained.

In a step S23, it is determined whether or not the cut-out operation is performed by the key input device 46, and when a determined result is YES, the process advances to a step S31 whereas when the determined result is NO, in a step S25, it is determined whether or not the reproduction resuming operation is performed by the key input device 46. When a determined result of the step S25 is NO, the process advances to a step S29 whereas when the determined result of the step S25 is YES, in a step S27, the H264 codec 36 is commanded to resume the H264 decoding process. As a result, displaying the moving image on the LCD monitor 34 is resumed. Upon completion of the step S27, the process returns to the step S15.

In the step S29, it is determined whether or not the reproducing end operation is performed by the key input device 46, and when a determined result is NO, the process returns to the step S23 whereas when the determined result is YES, the process returns to the step S19.

In the step S31, a still image acquiring process is executed. In the still image acquiring process, the image data of a frame maintained to be displayed on the LCD monitor 34 is read out from the moving image area 30a, and the read-out image data is written into the still image area 30c.

In a step S33, the JPEG codec 38 is commanded to execute the still-image compressing process. The JPEG codec 38 reads out the image data accommodated in the still image area 30c, compresses the read-out image data by the JPEG system, and writes the JPEG data thus obtained into the JPEG area 30d.

In a step S35, a frame number in a moving image file of a cut-out resource of the frame which is maintained to be displayed on the LCD monitor 34 is acquired. In a step S37, a file name of the moving image file of the cut-out resource is acquired, and in a step S39, photographing time and date of the moving image file of the cut-out resource is acquired.

In a step S41, a header of a still image file for accommodating the JPEG data is created by using the acquired file name, the photographing time and date and the frame number respectively acquired in the steps S35 to S39. File information and the frame number are described in the maker note of the Exif tag within the header.

In a step S43, a still image recording process is executed. In the still image recording process, a still image file is created in the recording medium 42 by using the header created in the step S41, the image data accommodated in the JPEG area 30d is read out, and the read-out image data is written into the created still image file. As a result, a still image file which accommodates the still image on a suspended screen is created in the recording medium 42. Upon completion of the process in the step S41, the process returns to the step S21.

In the step S45, the JPEG codec 38 and the LCD driver 32 are commanded to execute the reproducing process for the P-th image file. As a result, a still image is displayed on the LCD monitor 34.

In a step S47, a header of the P-th image file is referred to, and in a step S49, it is determined whether or not the file name of the moving image file of the cut-out resource is described in the maker note of the Exif tag in the referred header. When a determined result is YES, the process advances to a step S53 whereas when the determined result is NO, the process advances to a step S51. In the step S51, it is repeatedly determined whether or not the updating operation for the reproduced file is performed by the key input device 46, and when a determined result is updated from NO to YES, the process advances to a step S61.

In the step S53, an icon indicating a possibility of the moving image jumping operation is displayed on the LCD monitor 34. In a step S55, it is determined whether or not the moving image jumping operation is performed by the key input device 46, and when a determined result is YES, the process advances to a step S63 whereas when the determined result is NO, in a step S57, it is determined whether or not the updating operation for the reproduced file is performed by the key input device 46.

When a determined result of the step S57 is NO, the process returns to the step S55 whereas when the determined result of the step S57 is YES, in a step S59, the icon indicating the possibility of the moving image jumping operation is hidden. In the step S61, the variable P is incremented or decremented, and thereafter, the process returns to the step S3.

In the step S63, the file name described in the maker note of the Exif tag in the header of the P-th image file is referred to, and in a step S65, a moving image file having the reference file name is searched for in the recording medium 42. In a step S67, it is determined whether or not the moving image is discovered by the searching process, and when a determined result id NO, the process advances to a step S81 whereas when the determined result is YES, in a step S69, the photographing time and date described in the maker note of the P-th image file is referred to.

In a step S71, it is determined whether or not a moving image file in which a photographing time and date coincident with the reference photographing time and date is described in the discovered moving image file, and when a determined result is NO, the process advances to the step S81 whereas when the determined result is YES, in a step S73, the moving image file of which photographing time and date is coincident is regarded as a moving image file of a cut-out resource, and is determined as a target of the moving-image jumping.

In a step S75, the frame number described in the maker note of the P-th image file is referred to, and in a step S77, a reproducing start position of AAC data corresponding to the reference frame number is calculated.

In a step S79, the reproducing process for the moving image file of the moving-image jumping target is started from a frame of the reference frame number. In the reproducing process, the H264 codec 36, the LCD driver 32 and the AAC codec 24 are commanded to start the moving image reproduction of the moving-image jumping target. As a result, a moving image based on the frame after the reference frame number is displayed on the LCD monitor 34. Moreover, a reproduced sound after the calculated reproducing start position is outputted from the speaker 26 in synchronization with the reproduced moving image. After starting the reproducing process in the step S79, the process returns to the step S15.

In steps S81, S83 and S85, the file name, the photographing time and date and the frame number described in the maker note of the P-th image file are respectively deleted.

In a step S87, the icon indicating the possibility of the moving image jumping operation is hidden, and in a step S89, a message indicating that a moving image file of a jumping destination has not been discovered is displayed on the LCD monitor 34.

In a step S91, it is determined whether or not an operation of confirming the message is performed by the key input device 46, and when a determined result is updated from NO to YES, the process returns to the step S51.

As can be seen from the above-described explanation, the CPU 44 selects a desired frame image from among a plurality of frame images forming each of one or at least two moving images, and creates a still image based on the selected frame image. Moreover, the CPU 44 reproduces any one of one or at least two created still image in response to a still-image reproduction instruction, and detects, from among one or at least two moving image, a specific moving image having a frame image which forms a basis for the reproduced still image when a predetermined operation for the reproduced still image is accepted. Furthermore, the CPU 44 reproduces the detected specific moving image by using the noticed frame image as a reference.

The still image to be reproduced is equivalent to a still image that is based on the desired frame image selected from among the plurality of frame images forming each of one or at least two moving images. When the predetermined operation for the reproduced still image is accepted, the moving image having the desired frame image is detected from among one or at least two moving image, and the detected moving image is reproduced by using the desired frame image as a reference. Thereby, an operability of reproducing the moving image having the desired frame image is improved.

It is noted that, in this embodiment, the file name, the photographing time and date and the frame number of the moving image file of the cut-out resource are described in the maker note of the Exif tag within the header of the still image file. However, the file name, the photographing time and date and the frame number of the moving image file of the cut-out resource may be described in a table arranged in the recording medium 42 so as to refer to the table when the moving image jumping operation is performed.

Moreover, in this embodiment, when the moving image jumping operation is performed, the moving image having a frame after the frame which forms the basis for the still image file is reproduced. However, reproducing from a head position of the moving image file may be selected when the moving image jumping operation is performed.

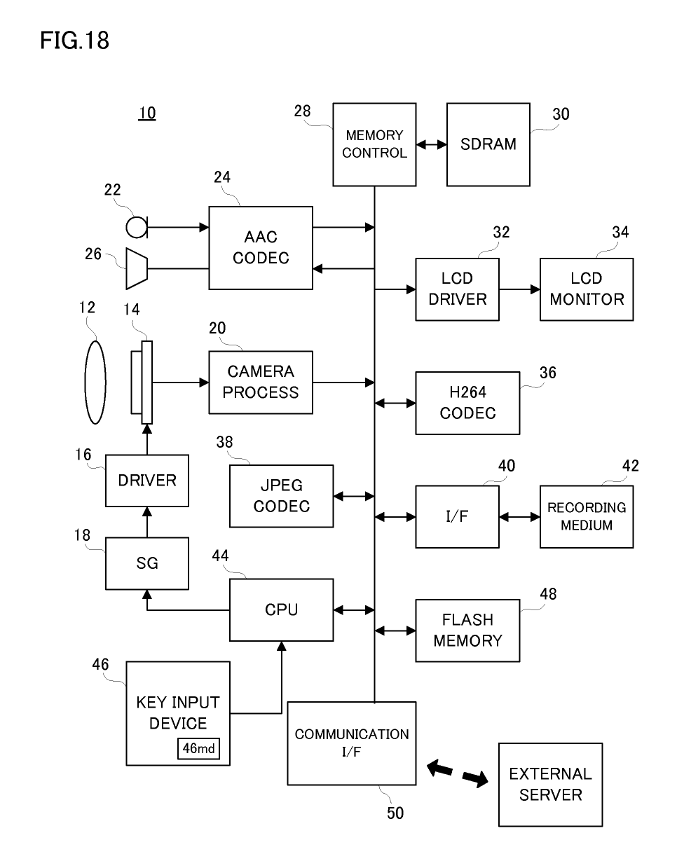

Moreover, in this embodiment, the control programs equivalent to the multi task operating system and the plurality of tasks executed thereby are previously stored in the flash memory 48. However, a communication I/F 50 may be arranged in the digital video camera 10 as shown in FIG. 18 so as to initially prepare a part of the control programs in the flash memory 48 as an internal control program whereas acquire another part of the control programs from an external server as an external control program. In this case, the above-described procedures are realized in cooperation with the internal control program and the external control program.

Moreover, in this embodiment, the processes executed by the CPU 44 are divided into a plurality of tasks including the reproducing task shown in FIG. 14 to FIG. 17. However, these tasks may be further divided into a plurality of small tasks, and furthermore, a part of the divided plurality of small tasks may be integrated into the main task. Moreover, when a transferring task is divided into the plurality of small tasks, the whole task or a part of the task may be acquired from the external server.

Moreover, in this embodiment, the present invention is explained by using a digital video camera, however, a personal computer, cell phone units and a smartphone may be applied to.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing apparatus, comprising:
a selector which selects a desired frame image from among a plurality of frame images forming each of one or at least two moving images;
a creator which creates a still image based on the frame image selected by said selector;
a first reproducer which reproduces any one of one or at least two still image created by said creator, in response to a still-image reproduction instruction;
a detector which detects, from among one or at least two moving images, a specific moving image having a frame image which is a basis for the still image reproduced by said first reproducer when a predetermined operation for the still image reproduced by said first reproducer is accepted; and
a second reproducer which reproduces the specific moving image detected by said detector by using the frame image noticed by said detector as a reference.

2. An image processing apparatus according to claim 1, further comprising:
an acquirer which acquires identification information identifying the frame image selected by said selector; and
an allocator which allocates the identification information acquired by said acquirer to the still image created by said creator, wherein said detector includes a searcher which searches for the specific moving image with reference to the identification information allocated by said allocator.

3. An image processing apparatus according to claim 2, further comprising a deleter which deletes identification information corresponding to the still image reproduced by said first reproducer out of the identification information allocated by said allocator, in response to a non-detection of said searcher.

4. An image processing apparatus according to claim 3, further comprising a controller which determines whether or not the identification information allocated by said allocator exists corresponding to the still image reproduced by said first reproducer so as to permit the predetermined operation corresponding to a positive determined result whereas restricts the predetermined operation corresponding to a negative determined result.

5. An image processing apparatus according to claim 2, wherein the identification information acquired by said acquirer includes position-identification information identifying a position of the frame image, and said second reproducer includes a designator which designates a reproducing start position based on the position-identification information.

6. An image processing program recorded on a non-transitory recording medium in order to control an image processing apparatus, the program causing a processor of the image processing apparatus to perform the steps comprising:
a selecting step of selecting a desired frame image from among a plurality of frame images forming each of one or at least two moving images;
a creating step of creating a still image based on the frame image selected by said selecting step;
a first reproducing step of reproducing any one of one or at least two still image created by said creating step, in response to a still-image reproduction instruction;
a detecting step of detecting, from among one or at least two moving images, a specific moving image having a frame image which is a basis for the still image reproduced by said first reproducing step when a predetermined operation for the still image reproduced by said first reproducing step is accepted; and
a second reproducing step of reproducing the specific moving image detected by said detecting step by using the frame image noticed by said detecting step as a reference.

7. An image processing method executed by an image processing apparatus, comprising:
a selecting step of selecting a desired frame image from among a plurality of frame images forming each of one or at least two moving images;
a creating step of creating a still image based on the frame image selected by said selecting step;
a first reproducing step of reproducing any one of one or at least two still image created by said creating step, in response to a still-image reproduction instruction;
a detecting step of detecting, from among one or at least two moving images, a specific moving image having a frame image which is a basis for the still image reproduced by said first reproducing step when a predetermined operation for the still image reproduced by said first reproducing step is accepted; and
a second reproducing step of reproducing the specific moving image detected by said detecting step by using the frame image noticed by said detecting step as a reference.
